(19) United States
(12) Patent Application Publication
(10) Pub. No.: US 2010/0098291 A1
(43) Pub. Date: Apr. 22, 2010

(54) METHODS AND SYSTEMS FOR OBJECT TYPE IDENTIFICATION

(75) Inventors: Peter J. Dugan, Ithaca, NY (US); Mark Olson, Owego, NY (US); Stephen R. Shafer, Vestal, NY (US); Rosemary D. Paradis, Vestal, NY (US)

Correspondence Address: BURNS & LEVINSON, LLP, 125 SUMMER STREET, BOSTON, MA, 02110, US

(73) Assignee: LOCKHEED MARTIN CORPORATION, Bethesda, MD (US)

(21) Appl. No.: 12/252,758

(22) Filed: Oct. 16, 2008

(51) Int. Cl. G06K 9/00

(52) U.S. Cl. 382/101; 382/103

(57) ABSTRACT

Method and system for identifying object type. In one embodiment, the method and systems of these teachings utilize a group of object measures and a decision algorithm in order to identify object type.

### BACKGROUND

This invention relates generally to identification of object type.

There are several applications in which the identification of the object type is important. For example, in systems such as current mail processing systems, the objects being processed are of different types and it is desirable to process objects of one type together. In the case of mail processing systems, the mail items are packages, flats, or bundles of letters. Conventional mail item typing software requires a priori knowledge. Using a priori information requires the customer to presort the mail. It would be desirable to discriminate between mail items automatically.

### BRIEF SUMMARY

In one embodiment, the method and systems of these teachings utilize a group of object measures and a decision algorithm in order to identify object type.

In one instance, the objects are mail items and the object type includes a bundle of mail items or a package.

In another instance, the decision algorithm includes the back propagation artificial neural network (ANN, also refereed to as a neural network) and test objects are used to train the back propagation neural network.

A variety of other embodiments are disclosed herein below as well as computer program products that implement those embodiments.

For a better understanding of the present teachings, together with other and further applications thereof, reference is made to the accompanying drawings and detailed description and its scope will be pointed out in the appended claims.

### BRIEF DESCRIPTION OF THE DRAWINGS

FIG. 1a is a graphical flowchart representation of an embodiment of the method of these teachings;

FIG. 1b is a graphical flowchart representation of another embodiment of the method of these teachings;

FIG. 2 is a schematic flowchart representation of yet another embodiment of the method of these teachings;

FIG. 3 is a graphical schematic representation of an embodiment of the system of these teachings;

FIG. 4 is a schematic block diagram representation of a portion of an embodiment of the system of these teachings;

FIGS. 5a, 5b are schematic block diagram representations of another portion of embodiments of the system of these teachings; and

FIG. 6 is a schematic graphical representation of a portion of an embodiment of the system and method of these teachings.

### DETAILED DESCRIPTION

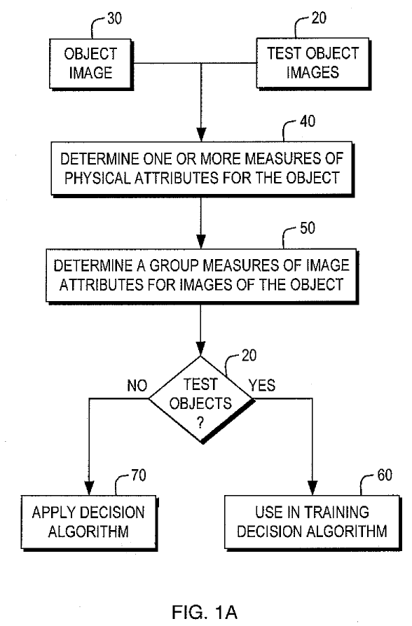

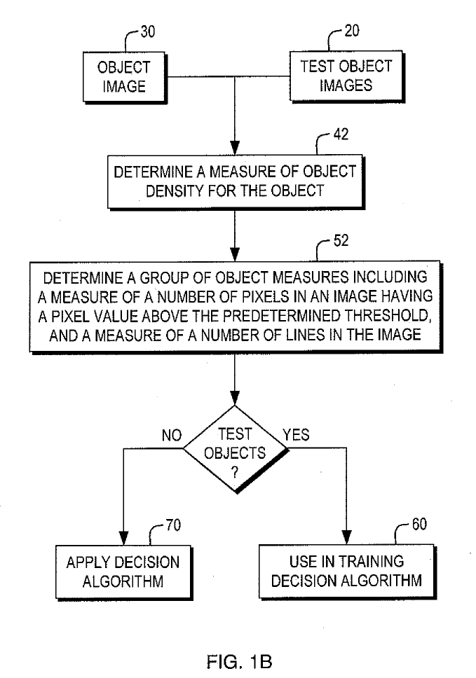

A flowchart of an embodiment of the method of these teachings is shown in FIG. 1a. Referring to FIG. 1a, the embodiment of the method of these teachings shown therein includes determining one or more measures of object physical attribute for an object (step 40, FIG. 1a) and determining a group of measures of image attributes for one or more images of the object (step 50, FIG. 1a) Those two steps are first applied to one or more images for each of a number of test subjects, where each test object has a predetermined object type. (For example, in the embodiment in which the objects are mail items, the object that would be in a package or a bundle of mail items.) The one or more measures of object physical attribute and the group of measures of image attributes for each of the test objects and their images, along with the predetermined knowledge of the object type for each of the test subjects, is used to train a decision algorithm (step 60, FIG. 1a), where the decision algorithm is capable of determining object type.

After the decision algorithm has been trained, the same two steps are applied to images of objects for which the object type is unknown. The one or more measures of object physical attribute and the group of measures of image attributes for each of the objects and the corresponding images are provided to the decision algorithm and the decision algorithm is utilized to determine the object type (step 70, FIG. 1a). It should be noted that, in determining the one or more physical attributes, predetermined quantities (such as, but not limited to, weight of the object) may be utilized.

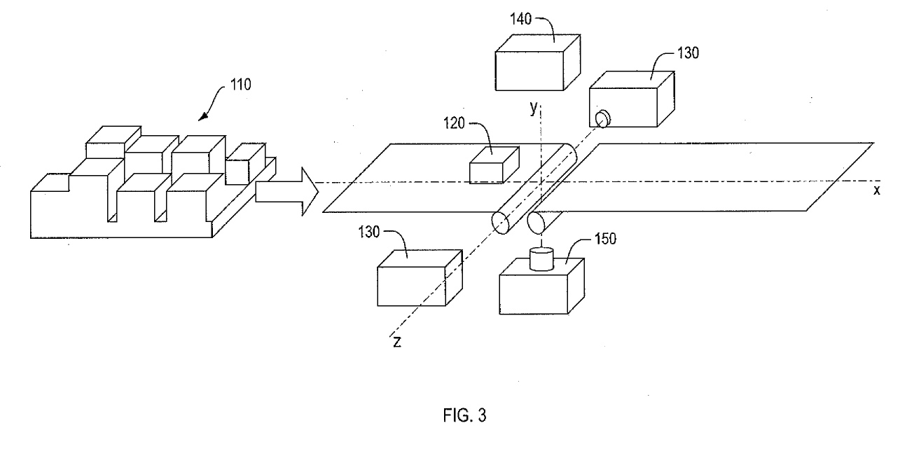

A flowchart of another embodiment of the method of these teachings is shown in FIG. 1b. In one instance, these teachings not being limited to only that instance, the one or more images of the object include one top and/or bottom image; a top/bottom image is an image obtained along a first axis perpendicular to a surface on which the object is located; (see, for example, FIG. 3). Referring to FIG. 1b, the embodiment of the method of these teachings shown therein includes determining a measure of object density (a physical attribute) for an object (step 42, FIG. 1b) and determining a group of object image attribute measures (step 52, FIG. 1b) where the group of object image attribute measures includes a measure of number of pixels in an image having a pixel value above a predetermined threshold and a measure of the number of lines in the image. Those two steps are first applied to one or more images for each of a number of test subjects, where each test object has a predetermined object type. (For example, in the embodiment in which the objects are mail items, the object that would be in a package or a bundle of mail items.) The measure of object density and the group of measures for each of the test objects, along with the predetermined knowledge of the object type for each of the test subjects, is used to train a decision algorithm (step 60, FIG. 1b), where the decision algorithm is capable of determining object type.

After the decision algorithm has been trained, the same two steps are applied to images of objects for which the object type is unknown. The measure is of object density and a group of measures for each of the objects is provided to the decision algorithm and the decision algorithm is utilized to determine the object type (step 70, FIG. 1b).

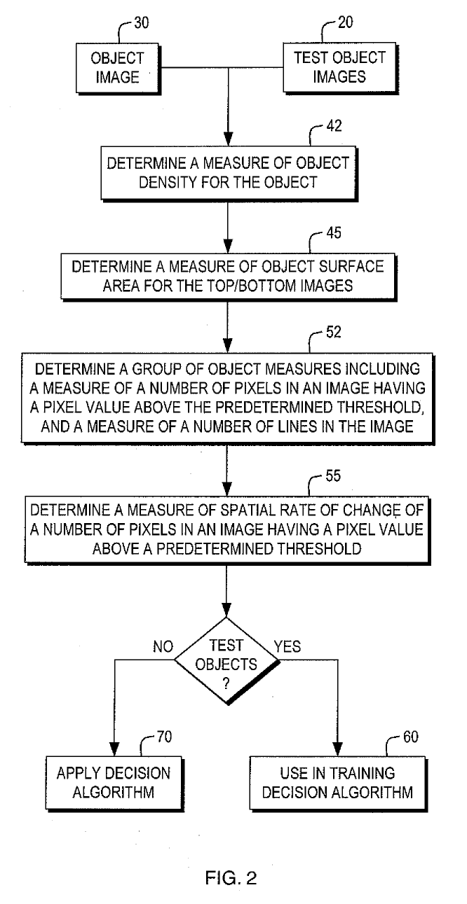

A further embodiment of the method of these teachings is shown in FIG. 2. In the embodiment shown in FIG. 2, the method of FIG. 1b also includes determining a measure of object surface area for top and/or bottom images (step 45, FIG. 2). In this embodiment, the one or more images of the object include one or more side images and one top and/or bottom image; a top/bottom image is an image obtained along a first axis perpendicular to a surface on which the object is located; a side image is an image obtained along a second axis perpendicular to the first axis and to a possible direction of motion of the object (see, for example, FIG. 3). The embodiment of the method shown in FIG. 2 also includes determining a measure of the spatial rate of change of the number of pixels in the image having a pixel value above the predetermine threshold (step 55, FIG. 2). For images of test objects, all the above described measures can be utilized in training the decision algorithm. For images of objects for which the type is unknown, all of the above described measures can be utilized as inputs to the decision algorithm and the decision algorithm provides a determination of object type.

Although the embodiments shown in FIGS. 1b and 2 are exemplary detailed embodiments, embodiments which are combinations or extensions of the embodiments shown in FIGS. 1b and 2 are also within the scope of these teachings. For example, these teachings not being limited to only the examples disclosed herein below, the method could be applied to embodiments in which the one or more images reduces to a single image (such as, but not limited to, the top or bottom image), or where the one or more images are two images) such as, but not limited to, a top and bottom image) or where the one or more images are three or four images (such as, but not limited to, one or two side images and a top and/or bottom image).

A portion of an embodiment of the system of these teachings is shown in FIG. 3. Referring to FIG. 3, a group of objects 110 of different types is provided to the system. Each one object 120 from the group is analyzed in order to determine the object type. The object is placed in a conveyor subsystem that transports the object in the direction labeled as “x.” In the embodiment shown in FIG. 3, two side cameras 130 and a top camera 140 and a bottom camera 150 obtain two side images, a top image and a bottom image of the object 120. The top and bottom images being are obtained along an axis (labeled “y”) perpendicular to the surface on which the object 120 is located and is being transported and also perpendicular to the direction of transport (“x”). The side images are images obtained along an axis (labeled as the “z” axis) perpendicular to the “y” axis and to the “x” axis.

It should be noted that a variety of possible cameras or other means for obtaining data for one or more images of the object 120 can be utilized in practicing these teachings. For example, any of the cameras can be a CCD camera, a CMOS camera, or any other camera using a digital acquisition module. Any of the cameras can be, for example, an analog camera combined with a digitizing system. (Also any image acquisition module with appropriate optics can be considered as a camera.) Also within the scopes of these teachings are image acquisition modules combined with software means for compressing the image (any predetermining compression algorithm can be used; for example, a JPEG algorithm, a JPEG 2000 algorithm, a wavelet based algorithm, a DCT-based algorithm or any other compression algorithm).

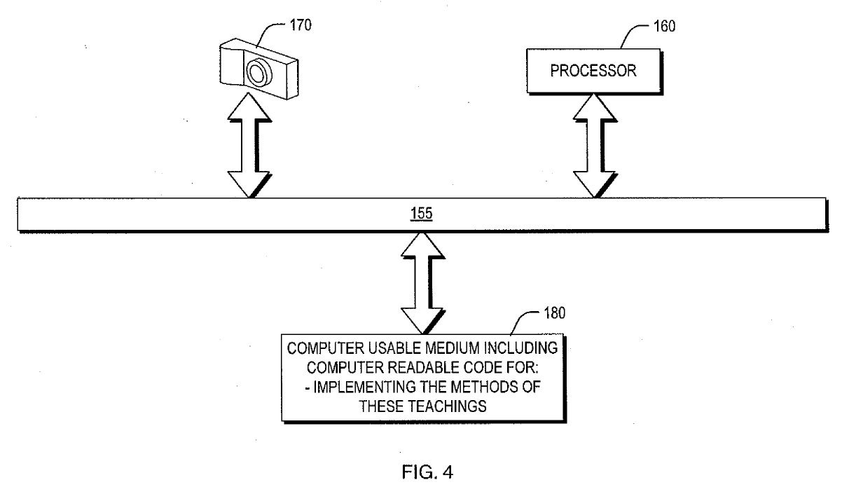

In one embodiment, shown in FIG. 4, the top and bottom and side cameras 130, 140, 150 (and in some instances, interface components to interface to the cameras 130, 140, 150 to the subsystem shown in FIG. 4; the interface components and the cameras being labeled as 170 in FIG. 4, also referred to as an image acquisition system) provide the images of the object 120 to one or more processors 160 and one or more computer usable media 180 having computer readable code embodied therein to cause the one or more processors 160 to implement the methods of these teachings.

In one instance, the computer usable media 180 has computer readable code embodied therein for causing the one or more processors 160 to receive the one or more images from the image acquisition system 170, determine or obtain one or more measures of object physical attribute for the object, determine, from each image for the object 120, a group of object image measures. In a detailed embodiment, the group of object measures includes a measure of a number of pixels, in each image for the object, having a pixel value above a predetermined threshold, and a measure of a number of lines in at least the side images for the object 120, and obtain, utilizing a decision algorithm having a measure of object density (one physical attribute) and the group of object image attribute measures as inputs, an identification of object type.

In another embodiment, when the one or more images include a top or a top and bottom image, the one or more computer usable media 180 has computer readable code embodied therein for causing the one or more processors 160 to determine a measure of surface area for the object 120. In another instance, the group of object measures includes a measure, for each image of the object, of the special rate of change of the number of pixels, in each of the images of the object, having a pixel value above a predetermined threshold. (In one instance, these teachings not be limited only to that instance, the threshold is selected to be slightly below substantially the maximum density in the image, usually referred to as black.)

In another embodiment, when the one or more images include a top, top and bottom, and side images, the one or more computer usable media 180 has computer readable code embodied therein for causing the one or more processors 160 to determine a measure of surface area for the object 120. In another instance, the group of object measures includes a measure, for each image of the object, of the special rate of change of the number of pixels, in each of the images of the object, having a pixel value above a predetermined threshold. In another instance, the group of side object measures includes a measure, for each side image of the object, of the number of lines in each of the image of the object. (In one instance, these teachings not be limited only to that instance, the threshold is selected to be slightly below substantially the maximum density in the image, usually referred to as black.)

When the object 120 is a test object for which the type is known, the subsystem shown in FIG. 4 includes computer readable code for causing the one or more processors 160 to obtain the one or more measures of object physical attribute and the group of object image attribute measures and utilize those results together with the known type to train the decision algorithm.

It should be noted that, although FIG. 4 shows one processor and one memory operatively connected by connection component 155 (in one instance, a computer bus), distributed embodiments in which the camera and interface component 170 also includes one or more processors and one or more computer usable media are also within the scope of these teachings. In one instance, for example, the camera and interface component 170 can include means, such as one or more processors and one more computer usable media having computer readable code embodied therein, for applying a compression algorithm to each image. In one instance, these teachings not be limited to only that instance, the compression algorithm is a wavelet-based algorithm (such as, but not limited to, the JPEG 2000 algorithm). In one embodiment, the one or more computer usable media 180 has computer readable code embodied therein for causing the one or more processors 160 to decompress the compressed image.

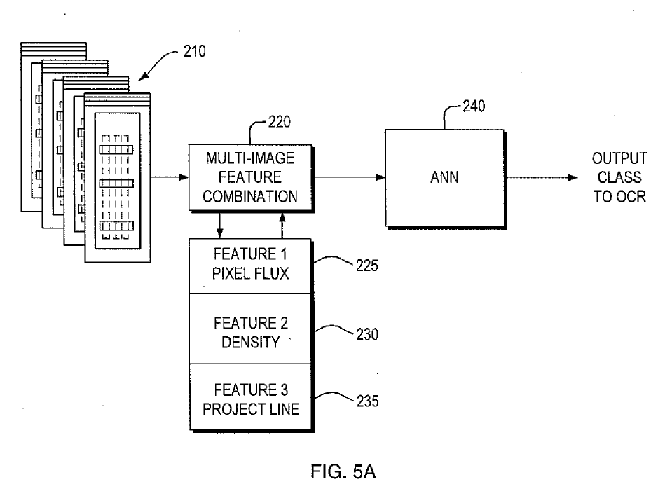

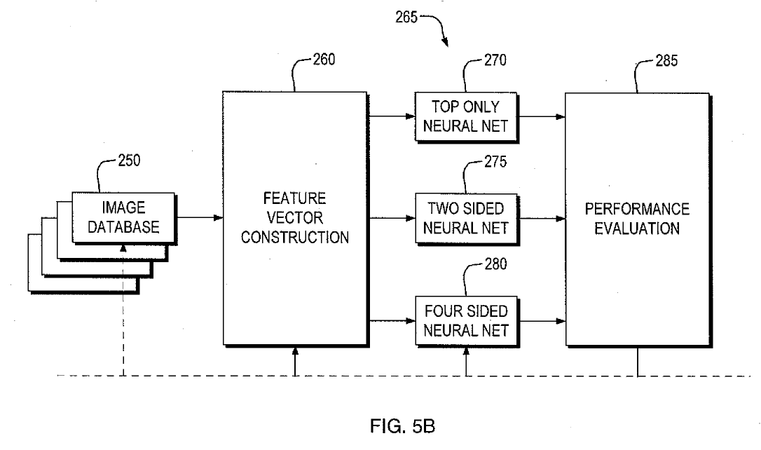

A block diagram representation of one portion of one embodiment of the system and method of these teachings is shown in FIG. 5a. Referring to FIG. 5a, top, bottom and side images 210 of an object are provided to a module 220 for determining a number of object measures. In the embodiment shown in FIG. 5a, these teachings not being limited to only this embodiment, the object image attribute measures are a pixel flux measure 225, a density measure 230 and a measure of the number of lines 235 in the image. In other embodiments, the object image attribute measures can include a differential pixel flux measure (not shown-an embodiment of which is disclosed hereinbelow) and the object attributes can include an object surface area (not shown). In one instance, the software (computer readable code) embodied in the computer usable medium (180, FIG. 4) and the one or more processors (160, FIG. 4) constitute means for determining the number of object image attribute measures. The object measures are combined into an object measure vector in the module 220. The object measure vector is provided to a decision algorithm 240. In the embodiment shown in the decision algorithm is a back propagation neural network. The decision algorithm can also be implemented in software although hardware implementations are also within the scope of these teachings. The implementation of the decision algorithm constitute means for obtaining an identification of object type.

It should be noted that a variety of other decision algorithms can be utilized in practicing these teachings. For example, the decision algorithm could be a Hopfield neural network that is trained by minimizing an error measure. A variety of other possible decision algorithm in which the algorithm is trained by minimizing an error metric are also within the scope of these teachings.

Another block diagram representation of one portion of one embodiment of the system and method of these teachings is shown in FIG. 5b. Referring to FIG. 5b, images 250 of an object are provided to a module 260 for construction of an object measure vector comprising a number of object measures. The feature vector is provided to a decision algorithm 265. In the embodiment shown in FIG. 5b, the decision algorithm 265 includes a number of sub algorithms, for example, but not limited to, neural network 270 for processing top images, a neural network 275 for processing two-sided images and a neural network 280 for processing four sided images. If the system shown in FIG. 5b is used to train the decision algorithm 265, a performance evaluation module 285 is also utilized. The performance evaluation module 285 can include, for example, these teachings not being limited to the following examples, the algorithms for training a back propagation neural network or the algorithms for minimizing an error metric and training a Hopfield neural network or a decision algorithm whose parameters are obtain obtained by minimizing an error metric. (In another instance, the evaluation module 285 can also include an arbitration or decision algorithm in order to identify object type from the results of the sub algorithms 270, 275, 280. The arbitration or decision algorithm can be implemented in software or hardware.) The software or hardware to implement the algorithms and the one or more processors to execute the software constitute means for training the decision algorithm. It should be noted that the embodiment shown in FIG. 5b can be modified to include other instances. Images of other instances of these teachings can be utilized or added to the images to 50 of the object. Additional object measures can be added to the object measure vector (feature vector) provided by the object measure vector providing module 260. Additional sub-algorithms can be added to or used to replace sub-algorithms in the decision algorithm 265.

In order to better illustrate the present teachings, an exemplary embodiment is presented below. It should be noted that these teachings are not limited to only this exemplary embodiment.

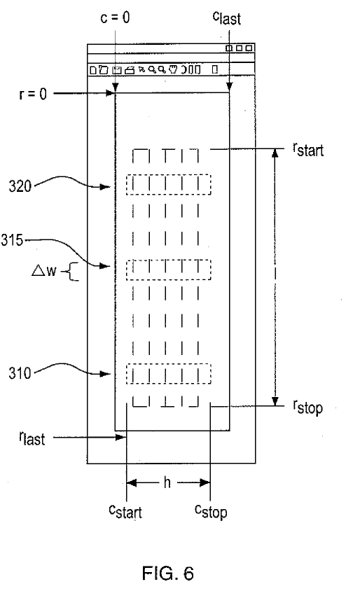

An image as it is used in one of the embodiments of the system and method of these teachings is shown in FIG. 6. Referring to FIG. 6, the following characteristics of the image are shown therein:

c=0 start of column buffer

r=0 start of row buffer

cₗₐₛₜ end of column buffer

rₗₐₛₜ end of row buffer

rₛₜₐᵣₜ starting row of object

cₛₜₐᵣₜ starting column of object

rₛₜₒₚ stopping row of object

cₛₜₒₚ stopping column of object

Δw Window size per slice

L object length

H object height (or width)

All of the above parameters are predetermined and provided to the method (or software in the system) of these teachings for determining the object measures. In one exemplary instance, Δw is 50 pixels in value.

In the exemplary embodiment, the measure of object density is calculated by obtaining the ratio of the object weight to volume, where volume is a product of length, width and height. The length, width and height can, in one instance, be obtained from the images of the object by conventional image processing means. In one instance, the weight is predetermined.

In one exemplary embodiment, an object surface area is also obtained for the top or bottom images. In one instance, the object surface area (pSA) is given by

$$pSA = \begin{matrix}2 * ( Length * Width ) + \\ 2 * ( Length * Height ) + \\ 2 * ( Width * Height ) .\end{matrix}$$

Another object measure utilized in the exemplary embodiment is a measure of a number of pixels in the image having a pixel value above the predetermined threshold (in the exemplary embodiment described herein, the threshold corresponds to substantially next to the highest density in the image, the so-called black; the measure is a measure of the number of black pixels). The measure of the number of pixels in the image having a pixel value above the predetermines threshold, which in the exemplary instance disclosed hereinbelow is the number of black pixels, is obtained for each of the top, bottom and side (left, right) images and is also referred to as the pixel flux. In the exemplary embodiment, the image is a black-and-white image and the pixel flux (pF[side], where side includes top, bottom and left and right, is given by

$$p F [ side ] = {\sum }_{r = {r}_{start}}^{{r}_{stop}} {\sum }_{c = {c}_{start}}^{{c}_{stop}} {I}_{image} ( r , c , side )$$

where I_{image} is the intensity value for a pixel, which in a black-and-white image is “1” for a black pixel and “0” for a white pixel. In another embodiment, a reverse color map is utilized where “1” is the value of a black pixel and “0” the value of a white pixel. It should be noted that these teachings are not limited to only these embodiments.

The exemplary embodiment also includes, in the group of object measures, a measure of a spatial rate of change of the number of pixels in the image having a pixel value above the predetermined threshold (in the exemplary embodiment described herein, the threshold corresponds to substantially next to the highest density in the image, the so-called black; the measure is a measure of the spatial rate of change of black pixels). In the exemplary embodiment, the image is a black-and-white image and the measure, referred to as the differential pixel flux (dpF[side]), of the spatial rate of change of the black pixels is given by

$$p F [ side ] = {\sum }_{r = {r}_{start}}^{{r}_{stop}} {\sum }_{c = {c}_{start}}^{{c}_{stop}} \frac{\partial {I}_{image}}{\partial r \partial c} ( r , c , side ) .$$

The group of object measures in the exemplary embodiment also includes a measure of the number of lines in one or more images for the object. In the exemplary embodiment, the number of lines is computed by the procedure disclosed hereinbelow. Referring to FIG. 6, the determination of the number of lines includes:
1. Determining the pixel density for each windowed area (310, 315, 320, FIG. 6; in the embodiment shown in FIG. 6 there are three windowed areas per object side and both the right and left sides are considered). In this exemplary embodiment, the pixel density is given by

$${ρ}_{slice - 1} ( x , side ) = {\sum }_{r = {r}_{start} + I / 4}^{{r}_{start} + I / 4 + Δ w} {I}_{image} ( r , x , side )$$

$${ρ}_{slice - 2} ( x , side ) = {\sum }_{r = {r}_{start} + I / 2}^{{r}_{start} + I / 2 + Δ w} {I}_{image} ( r , x , side )$$

$${ρ}_{slice - 3} ( x , side ) = {\sum }_{r = {r}_{start} + 3 I / 4}^{{r}_{start} + 3 I / 4 + Δ w} {I}_{image} ( r , x , side )$$

2. Determining the number of lines in each windowed area using the following expression

$${L}_{Side} [ n ] = {\sum }_{side = R , L}^{ } [ {\sum }_{n = 1 , 2 , 3}^{ } ( {\sum }_{x = {c}_{start}}^{{c}_{stop}} th < \vert \frac{\partial }{\partial x} {ρ}_{slice - n} ( x , side ) \vert ) ]$$

Where th is another predetermines threshold; in one instance,

th is given by

th=0.2max|ρₗᵢₙₑ₋ₙ(x,side)|
3. Determining the average number of lines, average over the windowed areas in the image of the right side and the windowed areas in the image of the left side; for the instance shown in FIG. 6, the average number of lines is given by

$${L}_{Ave} = \frac{( {\sum }_{n = 1 , 2 , 3}^{ } {L}_{R} [ n ] + {\sum }_{n = 1 , 2 , 3}^{ } {L}_{L} [ n ] )}{6} .$$

In one instance of the exemplary embodiment, the configuration shown in FIG. 5b is utilized. In that instance each of these three sub-algorithms, the neural network 270 for processing top images (Top), the neural network 275 for processing two-sided images (2 sided) and the neural network 280 for processing four sided images (4 sided), may use a different set of object measures. In the table below, the object measures utilized in the exemplary embodiment are listed and the sub algorithms in which their used are identified.

| | |
|---|---|
| Object density | Top, 2 sided, 4 sided |
| Object surface area | Top, 2 sided, 4 sided |
| Pixel flux[top] | Top, 2 sided, 4 sided |
| Pixel flux[bottom] | 2 sided, 4 sided |
| Pixel flux[left side] | 4 sided |
| Pixel flux[right side] | 4 sided |
| Differential pixel flux[top] | Top, 2 sided, 4 sided |
| Differential pixel flux[bottom] | 2 sided, 4 sided |
| Differential pixel flux[right | 4 sided |
| side] | |
| Differential pixel flux[left side | 4 sided |
| Lₐᵥₑ | 4 sided |

Although a detailed algorithm for the detection of lines has been disclosed hereinabove in relation to the exemplary embodiment, a variety of other line detection algorithms are within the scope of these teachings. (See for example, although these teachings are not limited only to the line detection algorithms described therein, V. Fontaine, T. G. Crowe, Evaluation of Four line detection Algorithms for Local Positioning in Densely Seeded Crops, Written for presentation at the CSAE/SCGR 2003 Meeting Montréal, Québec Jul. 6-9, 2003, which is incorporated by reference herein, and Jian Sun; Fengqi Zhou; Jun Zhou, A new fast line detection algorithm, ISSCAA 2006. 1st International Symposium on Systems and Control in Aerospace and Astronautics, Date: 19-21 Jan. 2006, Pages: 831-833, which is also incorporated by reference herein.)

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, or any other medium from which a computer can read. From a technological standpoint, a signal or carrier wave (such as used for Internet distribution of software) encoded with functional descriptive material is similar to a computer-readable medium encoded with functional descriptive material, in that they both create a functional interrelationship with a computer. In other words, a computer is able to execute the encoded functions, regardless of whether the format is a disk or a signal.

Although these teachings have been described with respect to various embodiments, it should be realized these teachings are also capable of a wide variety of further and other embodiments within the spirit and scope of the appended claims.

What is claimed is:

1. A method for identifying object type, the method comprising the steps of:
providing at least one image for each test object from a plurality of test objects; said each test object from a plurality of test objects having a pre-determined object type;
determining for each test object at least one measure of object physical attribute;
determining, for each test object, from each said at least one image for each test object, a group of measures of image attributes;
utilizing said measure of object physical attribute and said group of measures of image attributes for each test object to train a decision algorithm; the decision algorithm being capable of determining object type;
obtaining at least one image for an object;
determining at least one measure of object physical attribute for the object;
determining, from each said at least one image for the object, a group of measures of image attributes; and
obtaining, utilizing the trained decision algorithm having the measure of object physical attribute and the group of measures of image attributes as inputs, an identification of object type.

2. The method of claim 1 wherein said group of measures of image attributes comprises a measure of a number of pixels in said at least one image having a pixel value above the predetermined threshold, and a measure of a number of lines in said at least one image for each test object; and wherein said at least one measure of object physical attribute comprises a measure of an object density.

3. The method of claim 1 wherein said at least one image comprises at least one side image and at least one top/bottom image; a top/bottom image being an image obtained along a first axis perpendicular to a surface on which the object/test object is located; a side image being an image obtained along a second axis perpendicular to the first axis and to a possible direction of motion of the object/test object.

4. The method of claim 3 wherein said decision algorithm comprises two sub-algorithms.

5. The method of claim 1 wherein the test objects are mail items and the object is a mail item; and wherein the object type is a package or a bundle of mail items.

6. The method of claim 1 wherein the step of providing at least one image comprises the step of providing at least one compressed image.

7. The method of claim 2 wherein said group of measures of image attributes further comprises a measure of a spatial rate of change of said number of pixels in said at least one image of each test object having a pixel value above the predetermined threshold; and wherein said group of measures of image attributes further comprises a measure of a spatial rate of change of said number of pixels, in said at least one image for the object, having a pixel value above the predetermined threshold.

8. The method of claim 3 further comprising the steps of:
determining for said top/bottom image of each test object a measure of test object surface area; and
determining for said top/bottom image of the object a measure of surface area of the object.

9. A system for identifying object type, the system comprising:
an image acquisition system capable of obtaining at least one image of an object;
at least one processor; and
at least one computer usable medium having computer readable code embodied therein, said computer readable code being capable of causing said at least one processor to:
a. receive said at least one image from said image acquisition system;
b. determine at least one measure of object physical attribute for the object;
c. determine, from each said at least one image for the object, a group of measures of image attributes; and
d. obtain, utilizing a decision algorithm having said measure of object density and said group of object measures as inputs, an identification of object type.

10. The system of claim 9 wherein said group of measures of image attributes comprises a measure of a number of pixels in said at least one image having a pixel value above the predetermined threshold, and a measure of a number of lines in said at least one image for each test object; and wherein said at least one measure of object physical attribute comprises a measure of an object density.

11. The system of claim 10 wherein said computer readable code is also capable of causing said at least one processor to:
receive at least one image for each test object from a plurality of test objects; said each test object from said plurality of test objects having a pre-determined object type;
perform operations b) and c) to obtain at least one measure of object physical attribute for said each test object and said group of measures of image attributes for said at least one image of said each test object; and
utilize said at least one measure of object physical attribute for said each test object and said group of measures of image attributes for said at least one image of said each test object to train said decision algorithm.

12. The system of claim 9 wherein said at least one image comprises one side image and one top/bottom image; a top/bottom image being an image obtained along a first axis perpendicular to a surface on which the object is located; a side image being an image obtained along a second axis perpendicular to the first axis and to a possible direction of motion of the object.

13. The system of claim 12 wherein said decision algorithm comprises two sub-algorithms.

14. The system of claim 12 wherein said computer readable code is also capable of causing said at least one processor to:
determine for said top/bottom image of the object a measure of surface area of the object.

15. The system of claim 9 wherein said object is a mail item; and wherein the object type comprises a package or a bundle of mail items.

16. The system of claim 9 wherein said computer readable code is also capable of causing said at least one processor to:
apply, before determining the group of measures of image attributes, a compression algorithm to said at least one image of the object.

17. The system of claim 10 wherein said group of measures of image attributes further comprises a measure of a spatial rate of change of said number of pixels, in said at least one image of the object, having a pixel value above the predetermined threshold.

18. A system for identifying object type, the system comprising:
means for obtaining data for at least one image of an object;
means for determining at least one physical attribute for the object;
means for determining, from each said at least one image for the object, a plurality of measures of image attributes;
means for obtaining, utilizing a decision algorithm having said plurality of measures of image attributes and said at least one physical attribute as inputs, an identification of object type.

19. The system of claim 18 further comprising means for training said decision algorithm.

20. A computer program product for identifying object type, the computer program product comprising:
a computer usable medium having computer readable code embodied there in, said computer readable code being capable of causing at least one processor to:
a. receive at least one image of an object from an image acquisition system;
b. determine at least one measure of object physical attribute for the object;
c. determine, from each said at least one image for the object, a group of measures of image attributes; and
d. obtain, utilizing a decision algorithm having said at least one measure of object physical attribute and said group of measures of image attributes as inputs, an identification of object type.

21. The computer program product of claim 20 wherein said computer readable code is also capable of causing said at least one processor to:
receive at least one image for each test object from a plurality of test subjects;
perform operations b) and c) to obtain at least one measure of object physical attribute for said each test object and said group of measures of image attributes for said at least one image of said each test object; and
utilize said at least one measure of object physical attribute for said each test object and said group of measures of image attributes for said at least one image of said each test object for said each test object to train said decision algorithm.

22. The computer program product of claim 20 wherein said group of measures of image attributes comprises a measure of a number of pixels in said at least one image having a pixel value above the predetermined threshold, and a measure of a number of lines in said at least one image for each test object; and wherein said at least one measure of object physical attribute comprises a measure of object density.

23. The computer program product of claim 22 wherein said at least one image comprises at least one side image and at least one top/bottom image; a top/bottom image being an image obtained along a first axis perpendicular to a surface on which the object is located; a side image being an image obtained along a second axis perpendicular to the first axis and to a possible direction of motion of the object.

24. The computer program product of claim 23 wherein said computer readable code is also capable of causing said at least one processor to:
determine for said top/bottom image of the object a measure of surface area of the object.

25. The computer program product of claim 20 wherein said computer readable code is also capable of causing said at least one processor to:
apply, before determining the group of measures of image attributes, a compression algorithm to said at least one image of the object.

26. The computer program product of claim 22 wherein said group of measures of image attributes further comprises a measure of a spatial rate of change of said number of pixels, in said at least one image of the object, having a pixel value above the predetermined threshold.
